(19) United States
(12) Patent Application Publication
(10) Pub. No.: US 2026/0237994 A1
(43) Pub. Date: Aug. 13, 2026

(54) OVERCURRENT PROTECTION CIRCUIT, SEMICONDUCTOR DEVICE, ELECTRONIC DEVICE AND VEHICLE

(71) Applicant: ROHM CO., LTD., Kyoto-shi (JP)

(72) Inventors: Joita ADRIAN, Kyoto-shi (JP); Toru TAKUMA, Kyoto-shi (JP)

(21) Appl. No.: 19/556,430

(22) Filed: Mar. 4, 2026

Related U.S. Application Data
(63) Continuation of application No. PCT/JP2024/027548, filed on Aug. 1, 2024.

(30) Foreign Application Priority Data
Sep. 7, 2023 (JP) 2023-145448

(51) Int. Cl. H02H 3/08; B60R 16/033

(52) U.S. Cl. CPC H02H 3/08; B60R 16/033

(57) ABSTRACT

An overcurrent protection circuit includes: a sense signal generation circuit configured to generate a sense signal according to a current to be monitored; a count completion value setting circuit configured to set a count completion value according to results of comparisons between a second sense signal corresponding to the sense signal and threshold values; and a counter configured to count up a count value when the current to be monitored is greater than a count start threshold value, and to forcibly stop the current to be monitored when the count value reaches the count completion value.

### CROSS REFERENCE TO RELATED APPLICATIONS

This application is a continuation under 35 U.S.C. § 120 of PCT/JP2024/027548, filed Aug. 1, 2024, which is incorporated herein by reference, and which claimed priority to Japanese Application No. 2023-145448, filed Sep. 7, 2023. The present application likewise claims priority under 35 U.S.C. § 119 to Japanese Application No. 2023-145448, filed Sep. 7, 2023, the entire content of which is also incorporated herein by reference.

### TECHNICAL FIELD

The present disclosure relates to an overcurrent protection circuit, a semiconductor device, an electronic device and a vehicle.

### BACKGROUND ART

The applicant of the present application has proposed a large number of new techniques on semiconductor devices called an IPD [intelligent power device] and an SPS [smart power switch] (see, for example, Patent Document 1).

### RELATED ART DOCUMENT

### Patent Document

Patent Document 1: International Publication No. 2017/187785

### BRIEF DESCRIPTION OF DRAWINGS

FIG. 1 is a diagram showing an example of the configuration of an electronic device which includes a semiconductor device;

FIG. 2 is a block circuit diagram showing the electrical structure of the semiconductor device;

FIG. 3 is a diagram showing an example of an electronic device which includes mechanical fuses;

FIG. 4 is a diagram showing an example of a semiconductor device which replaces mechanical fuses;

FIG. 5 is a diagram showing a cross section of a wire;

FIG. 6 is a diagram showing an equivalent model of an insulator;

FIG. 7 is a diagram showing a typical current-time characteristic;

FIG. 8 is a diagram showing an embodiment of an overcurrent protection circuit;

FIG. 9 is a diagram showing an example of the configuration of a counter;

FIG. 10 is a diagram showing an example of an overcurrent protection operation;

FIG. 11 is a diagram showing a relationship between a count value and an output current;

FIG. 12 is a diagram showing a current-time characteristic in the present embodiment;

FIG. 13 is a diagram showing a current-time characteristic in a variation;

FIG. 14 is a diagram showing the first configuration example of a sense signal generation circuit;

FIG. 15 is a diagram showing the second configuration example of the sense signal generation circuit;

FIG. 16 is a diagram showing a variation of a count completion value setting circuit;

FIG. 17 is a diagram showing an external view of a vehicle; and

FIG. 18 is a diagram showing a signal system in the vehicle.

### DESCRIPTION OF EMBODIMENTS

### <Electronic Device>

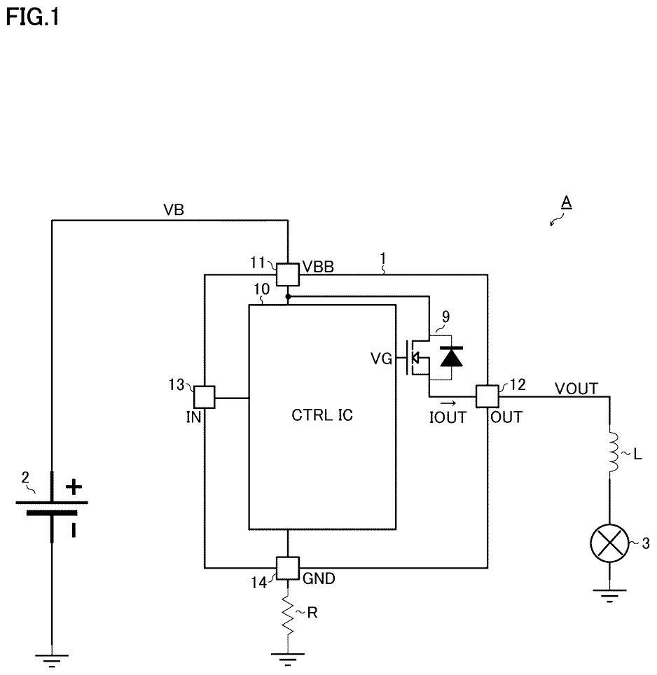

FIG. 1 is a diagram showing an example of the configuration of an electronic device which includes a semiconductor device. The electronic device A of the present configuration example includes a semiconductor device 1, a direct-current power supply 2 and a load 3.

The semiconductor device 1 is a high-side switch IC (a type of IPD) which electrically conducts/interrupts between the direct-current power supply 2 and the load 3, and integrates a power MISFET [metal insulator semiconductor field effect transistor] 9 and a controller 10.

The semiconductor device 1 includes a plurality of external electrodes as a means for establishing electrical connection with the outside of the device. With reference to the figure, the semiconductor device 1 includes a drain electrode 11 (corresponding to a power supply electrode VBB), a source electrode 12 (corresponding to an output electrode OUT), an input electrode 13 (corresponding to an input electrode IN) and a reference voltage electrode 14 (corresponding to a ground electrode GND).

The power MISFET 9 is an example of an insulated gate power transistor (=output switch), and functions as a high-side switch element which electrically conducts/interrupts between the drain electrode 11 and the source electrode 12.

The controller 10 includes a plurality of types of function circuits which realize various functions. Examples of the various types of function circuits include a circuit which generates a gate control signal VG for driving and controlling the power MISFET 9 based on an electrical signal from the outside.

The drain electrode 11 transmits a power supply voltage VB to the drain of the power MISFET 9 and various types of circuits in the controller 10. The source electrode 12 is connected to the source of the power MISFET 9, and transmits an output voltage VOUT and an output current IOUT to the load 3. A signal line (for example, a wire harness) provided between the source electrode 12 and the load 3 generally has an inductance component L (and a resistance component). The input electrode 13 transmits an input voltage (=input signal IN) for driving the controller 10. The reference voltage electrode 14 transmits a reference voltage (for example, a ground voltage) to the controller 10. A resistance component R is generally present between the reference voltage electrode 14 and a ground end.

### <Semiconductor Device>

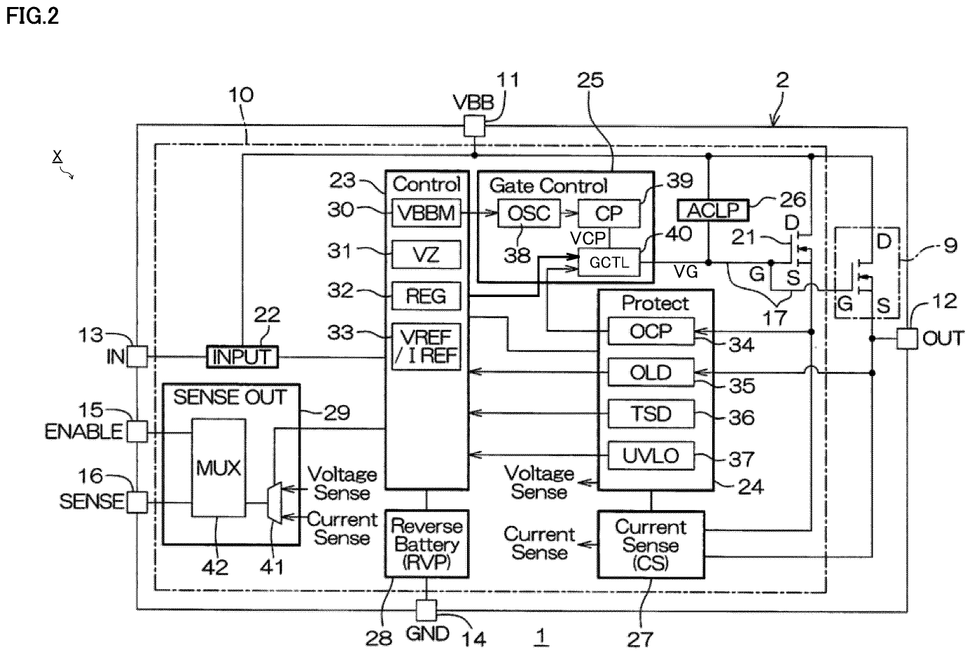

FIG. 2 is a block circuit diagram showing the electrical structure of the semiconductor device 1 shown in FIG. 1. In the following description, a case where the semiconductor device 1 is installed in a vehicle is used as an example. When the semiconductor device 1 is installed in the vehicle, the semiconductor device 1 can be applied as a high-side switch for controlling the energization of a light source such as a bulb lamp or an LED [light emitting diode] lamp or another type of electronic control device.

The semiconductor device 1 includes the drain electrode 11, the source electrode 12, the input electrode 13, the reference voltage electrode 14, an enable electrode 15, a sense electrode 16, a gate control wire 17, the power MISFET 9 and the controller 10.

The drain electrode 11 (=power supply electrode VBB) is connected to the direct-current power supply 2. The drain electrode 11 provides the power supply voltage VB to the power MISFET 9 and the controller 10. The power supply voltage VB may be equal to or greater than 10 V and equal to or less than 20 V. On the other hand, the source electrode 12 (=output electrode OUT) is connected to the load 3.

The input electrode 13 (=input electrode IN) may be connected to a MCU [micro controller unit], a DC/DC converter, an LDO [low drop out] regulator and the like. The input electrode 13 provides an input voltage to the controller 10. The input voltage may be equal to or greater than 1 V and equal to or less than 10 V. The reference voltage electrode 14 is connected to a reference voltage wire (ground end). The reference voltage electrode 14 provides the reference voltage to the power MISFET 9 and the controller 10.

The enable electrode 15 may be connected to the MCU. An electrical signal for enabling or disabling a part or all of functions of the controller 10 is input to the enable electrode 15. The sense electrode 16 transmits an electrical signal for detecting an abnormality of the controller 10 to the outside of the device. The sense electrode 16 may be pulled up or down by a resistor.

The gate of the power MISFET 9 is connected to the controller 10 (in particular, a gate control circuit 25 which will be described later) via the gate control wire 17. The drain of the power MISFET 9 is connected to the drain electrode 11. The source of the power MISFET 9 is connected to the controller 10 (in particular, a current detection circuit 27 which will be described later) and the source electrode 12.

The controller 10 includes a sensor MISFET 21, an input circuit 22, a current/voltage control circuit 23, a protection circuit 24, the gate control circuit 25, an active clamp circuit 26, the current detection circuit 27, a power supply reverse connection protection circuit 28 and an abnormality detection circuit 29.

The gate of the sensor MISFET 21 is connected to the gate control circuit 25. The drain of the sensor MISFET 21 is connected to the drain electrode 11. The source of the sensor MISFET 21 is connected to the current detection circuit 27.

The input circuit 22 is connected to the input electrode 13 and the current/voltage control circuit 23. The input circuit 22 may include a Schmitt trigger circuit. The input circuit 22 shapes the waveform of an electrical signal applied to the input electrode 13. A signal generated by the input circuit 22 is input to the current/voltage control circuit 23.

The current/voltage control circuit 23 is connected to the protection circuit 24, the gate control circuit 25, the power supply reverse connection protection circuit 28 and the abnormality detection circuit 29. The current/voltage control circuit 23 may include a logic circuit.

The current/voltage control circuit 23 generates various voltages according to the electrical signal from the input circuit 22 and an electrical signal from the protection circuit 24. In this form, the current/voltage control circuit 23 includes a drive voltage generation circuit 30, a first constant voltage generation circuit 31, a second constant voltage generation circuit 32 and a reference voltage/reference current generation circuit 33.

The drive voltage generation circuit 30 generates a drive voltage for driving the gate control circuit 25. The drive voltage may be set to a value obtained by subtracting a predetermined value from the power supply voltage VB. The drive voltage generation circuit 30 may generate the drive voltage which is obtained by subtracting 5 V from the power supply voltage VB and is equal to or greater than 5 V and equal to or less than 15 V. The drive voltage is input to the gate control circuit 25.

The first constant voltage generation circuit 31 generates a first constant voltage for driving the protection circuit 24. The first constant voltage generation circuit 31 may include a Zener diode or a regulator circuit (here, the Zener diode). The first constant voltage may be equal to or greater than 1 V and equal to or less than 5 V. The first constant voltage is input to the protection circuit 24 (more specifically, a load open detection circuit 35 which will be described later or the like).

The second constant voltage generation circuit 32 generates a second constant voltage for driving the protection circuit 24. The second constant voltage generation circuit 32 may include a Zener diode or a regulator circuit (here, the regulator circuit). The second constant voltage may be equal to or greater than 1 V and equal to or less than 5 V. The second constant voltage is input to the protection circuit 24 (more specifically, an overheat protection circuit 36 and a low voltage malfunction suppression circuit 37 which will be described later).

The reference voltage/reference current generation circuit 33 generates the reference voltage and a reference current for various types of circuits. The reference voltage may be equal to or greater than 1 V and equal to or less than 5 V. The reference current may equal to or greater than 1 mA and equal to or less than 1 A. The reference voltage and the reference current are input to various types of circuits. When the various types of circuits include a comparator, the reference voltage and the reference current may be input to the comparator.

The protection circuit 24 is connected to the current/voltage control circuit 23, the gate control circuit 25, the abnormality detection circuit 29, the source of the power MISFET 9 and the source of the sensor MISFET 21. The protection circuit 24 includes an overcurrent protection circuit 34, the load open detection circuit 35, the overheat protection circuit 36 and the low voltage malfunction suppression circuit 37.

The overcurrent protection circuit 34 protects the power MISFET 9 from an overcurrent. The overcurrent protection circuit 34 is connected to the gate control circuit 25 and the source of the sensor MISFET 21. The overcurrent protection circuit 34 may include a current monitor circuit. A signal generated by the overcurrent protection circuit 34 is input to the gate control circuit 25 (more specifically, a drive signal output circuit 40 which will be described later).

The load open detection circuit 35 detects the short-circuit state and the open state of the power MISFET 9. The load open detection circuit 35 is connected to the current/voltage control circuit 23 and the source of the power MISFET 9. A signal generated by the load open detection circuit 35 is input to the current/voltage control circuit 23.

The overheat protection circuit 36 monitors the temperature of the power MISFET 9 to protect the power MISFET 9 from an excessive temperature rise. The overheat protection circuit 36 is connected to the current/voltage control circuit 23. The overheat protection circuit 36 may include a temperature-sensitive device such as a temperature-sensitive diode or a thermistor. A signal generated by the overheat protection circuit 36 is input to the current/voltage control circuit 23.

When the power supply voltage VB is less than a predetermined value, the low voltage malfunction suppression circuit 37 suppresses the malfunction of the power MISFET 9. The low voltage malfunction suppression circuit 37 is connected to the current/voltage control circuit 23. A signal generated by the low voltage malfunction suppression circuit 37 is input to the current/voltage control circuit 23.

The gate control circuit 25 controls the on-state and the off-state of the power MISFET 9 and the on-state and the off-state of the sensor MISFET 21. The gate control circuit 25 is connected to the current/voltage control circuit 23, the protection circuit 24, the gate of the power MISFET 9 and the gate of the sensor MISFET 21.

The gate control circuit 25 outputs the gate control signal VG to the gate control wire 17 according to an electrical signal from the current/voltage control circuit 23 and the electrical signal from the protection circuit 24. The gate control signal VG is input via the gate control wire 17 to the gate of the power MISFET 9 and the gate of the sensor MISFET 21. More specifically, the gate control circuit 25 controls the gate control signal VG according to the electrical signal (input signal) applied to the input electrode 13 to turn on and off the power MISFET 9.

More specifically, the gate control circuit 25 includes an oscillator circuit 38, a charge pump circuit 39 and the drive signal output circuit 40. The oscillator circuit 38 oscillates in response to an electric signal from the current/voltage control circuit 23 to generate a predetermined electrical signal. The electrical signal generated by the oscillator circuit 38 is input to the charge pump circuit 39. The charge pump circuit 39 generates a step-up voltage VCP based on the electrical signal from the oscillator circuit 38. The step-up voltage VCP generated by the charge pump circuit 39 is input to the drive signal output circuit 40.

The drive signal output circuit 40 is operated by receiving the step-up voltage VCP output from the charge pump circuit 39, and generates the gate control signal VG according to the electrical signal from the protection circuit 24 (more specifically, the overcurrent protection circuit 34). The gate control signal VG is input via the gate control wire 17 to the gate of the power MISFET 9 and the gate of the sensor MISFET 21. The sensor MISFET 21 and the power MISFET 9 are controlled simultaneously by the gate control circuit 25.

The active clamp circuit 26 protects the power MISFET 9 from a back electromotive force. The active clamp circuit 26 is connected to the drain electrode 11, the gate of the power MISFET 9 and the gate of the sensor MISFET 21. The active clamp circuit 26 may include a plurality of diodes.

The active clamp circuit 26 may include a plurality of diodes connected in forward bias. The active clamp circuit 26 may include a plurality of diodes connected in reverse bias. The active clamp circuit 26 may include a plurality of diodes connected in forward bias and a plurality of diodes connected in reverse bias.

The plurality of diodes may include a pn junction diode or a Zener diode, or a pn junction diode and a Zener diode. The active clamp circuit 26 may include a plurality of Zener diodes connected in forward bias. The active clamp circuit 26 may include a Zener diode and a pn junction diode connected in reverse bias.

The current detection circuit 27 detects a current flowing through the power MISFET 9 and the sensor MISFET 21. The current detection circuit 27 is connected to the protection circuit 24, the abnormality detection circuit 29, the source of the power MISFET 9 and the source of the sensor MISFET 21. The current detection circuit 27 generates a current detection signal according to an electrical signal (=output current IOUT) generated by the power MISFET 9 and an electrical signal (=sense current ISNS indicating the same behavior as the output current IOUT) generated by the sensor MISFET 21. The current detection signal is input to the abnormality detection circuit 29.

When the direct-current power supply 2 is reversely connected, the power supply reverse connection protection circuit 28 protects the current/voltage control circuit 23, the power MISFET 9 and the like from a reverse voltage. The power supply reverse connection protection circuit 28 is connected to the reference voltage electrode 14 and the current/voltage control circuit 23.

The abnormality detection circuit 29 monitors the voltage of the protection circuit 24. The abnormality detection circuit 29 is connected to the current/voltage control circuit 23, the protection circuit 24 and the current detection circuit 27. When an abnormality (such as a variation in voltage) occurs in any one of the overcurrent protection circuit 34, the load open detection circuit 35, the overheat protection circuit 36 and the low voltage malfunction suppression circuit 37, the abnormality detection circuit 29 generates an abnormality detection signal corresponding to the voltage of the protection circuit 24, and outputs it to the outside.

More specifically, the abnormality detection circuit 29 includes a first multiplexer circuit 41 and a second multiplexer circuit 42. The first multiplexer circuit 41 includes two input portions, one output portion and one selective control input portion. The protection circuit 24 and the current detection circuit 27 are connected to the input portions of the first multiplexer circuit 41. The second multiplexer circuit 42 is connected to the output portion of the first multiplexer circuit 41. The current/voltage control circuit 23 is connected to the selective control input portion of the first multiplexer circuit 41.

The first multiplexer circuit 41 generates the abnormality detection signal according to the electrical signal from the current/voltage control circuit 23, a voltage detection signal from the protection circuit 24 and a current detection signal from the current detection circuit 27. The abnormality detection signal generated by the first multiplexer circuit 41 is input to the second multiplexer circuit 42.

The second multiplexer circuit 42 includes two input portions and one output portion. The output portion of the second multiplexer circuit 42 and the enable electrode 15 are connected to the input portions of the second multiplexer circuit 42. The sense electrode 16 is connected to the output portion of the second multiplexer circuit 42.

When the MCU is connected to the enable electrode 15, and the pull-up or pull-down resistor is connected to the sense electrode 16, an on-signal is input to the enable electrode 15 from the MCU, and the abnormality detection signal is taken out from the sense electrode 16. The abnormality detection signal is converted into an electrical signal by the resistor connected to the sense electrode 16. An abnormality in the state of the semiconductor device 1 is detected based on this electrical signal.

### <Problems in Mechanical Fuses>

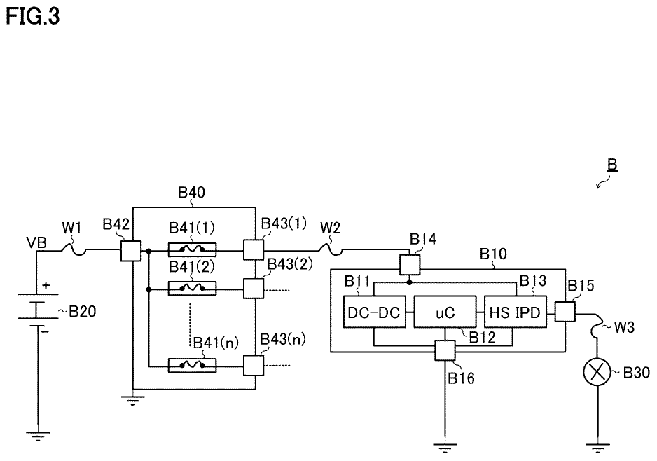

FIG. 3 is a diagram showing an example of an electronic device which includes mechanical fuses. The electronic device B of the present configuration example includes a control unit B10, a battery B20, a load B30 and a fuse box B40.

The control unit B10 receives the supply of the power supply voltage VB from the battery B20 via the fuse box B40 to drive the load B30. With reference to the figure, the control unit B10 includes a DC/DC converter B11, a microcomputer B12, an upper switch B13, a power supply electrode B14, an output electrode B15 and a reference voltage electrode B16. The control unit B10 may be, for example, an ECU [electronic control unit].

The DC/DC converter B11 generates a desired internal power supply voltage from the power supply voltage VB, and outputs the internal power supply voltage to the portions (such as the microcomputer B12) of the control unit B10.

The microcomputer B12 receives the supply of the internal power supply voltage from the DC/DC converter B11 to perform on/off control on the upper switch B13.

The upper switch B13 is connected between the power supply electrode B14 and the output electrode B15, and is subjected to the on/off control corresponding to an instruction from the microcomputer B12.

The power supply electrode B14 receives the supply of the power supply voltage VB from the battery B20 via the fuse box B40. For example, the output electrode B15 is connected to the load B30 via a wire W3. For example, the reference voltage electrode B16 is connected to the ground end.

The fuse box B40 includes n fuses B41 (1) to B41 (n), an input electrode B42 and output electrodes B43 (1) to B43 (n).

The fuse B41 (i) (where i=1, 2, . . . and n) is connected between the input electrode B42 and the output electrode B43 (i). The fuse B41 (i) is a so-called mechanical fuse, and is blown due to Joule heat when a current exceeding its rated current flows through the fuse B41 (i), with the result that the circuit is protected.

For example, the input electrode B42 is connected to the positive end (=the application end of the power supply voltage VB) of the battery B20 via a wire W1. For example, the output electrode B43 (1) is connected to the power supply electrode B14 of the control unit B10 via a wire W2.

In the electronic device B using the fuse box B40, there are two problems. The first problem is that the reaction time (=the time required for the blowing) of the fuse B41 (i) is unclear and is not accurate. Hence, damage to the control unit B10 to be protected can often be a problem. The second problem is that it is necessary to replace the fuse B41 (i) which has been blown. In most cases, a complete system replacement (=replacement of the fuse box B40) is required.

In order to solve the problem described above, for example, it is conceivable to use an electronic fuse (so-called e-fuse) utilizing an IPD instead of the mechanical fuse.

### <Replacement of Mechanical Fuses>

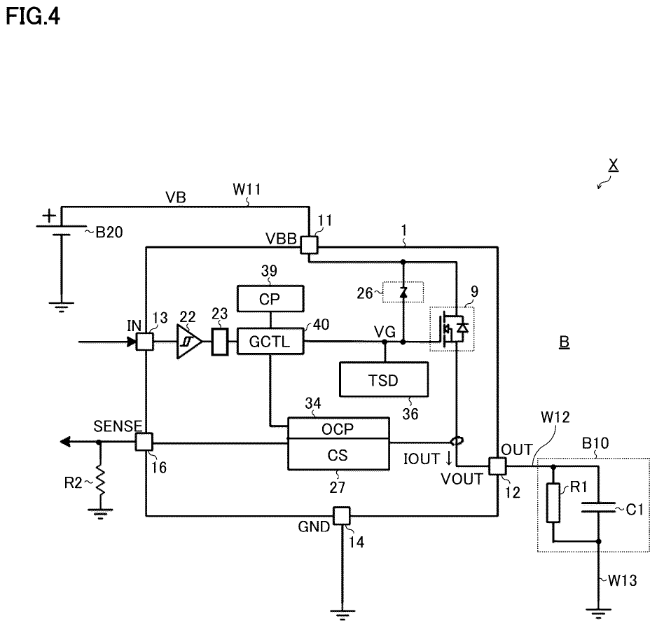

FIG. 4 is a diagram showing an example of a semiconductor device which replaces the mechanical fuses. In the electronic device B of the present configuration example, the fuse box B40 is replaced by the semiconductor device 1 based on FIG. 3 described above.

The electronic device B may be incorporated in a vehicle X. The battery B20 corresponds to a direct-current power supply which supplies power to the electronic device B. Between the battery B20 and the electronic device B, a wire W11 which serves as a current path from the battery B20 to the electronic device B may be provided. Between the electronic device B and the control unit B10, a wire W12 which serves as a current path from the electronic device B to the control unit B10 may be provided. Between the control unit B10 and an earth (ground end), a wire W13 which serves as a current path from the control unit B10 and the earth may be provided.

The control unit B10 which is externally attached to the source electrode 12 (=output electrode OUT) of the semiconductor device 1 functions as a capacitive load having a large capacitance value from the viewpoint of the semiconductor device 1. Hence, the control unit B10 is equivalently shown as the parallel circuit of a capacitor C1 and a resistor R1. In the figure, a resistor R2 for pulling down the sense electrode 16 to the ground end is explicitly shown.

The semiconductor device 1 basically has the same configuration as in FIG. 2 described previously. Hence, the constituent elements which have already been described are identified with the same symbols as in FIG. 2, thus repeated description is omitted and main constituent elements and constituent elements related thereto will be mainly described.

The power MISFET 9 is an output switch which electrically conducts/interrupts between the drain electrode 11 and the source electrode 12 according to the gate control signal VG.

The overcurrent protection circuit 34 detects a current to be monitored and controls the gate control signal VG to perform overcurrent protection. The current to be monitored may be the output current IOUT flowing through the power MISFET 9. For example, the overcurrent protection circuit 34 may restrict the output current IOUT to an overcurrent protection threshold value Iocp or the like (so-called current restriction operation). The overcurrent protection circuit 34 may forcibly turn off and restart the power MISFET 9 in a repeated manner each time the output current IOUT is increased to the overcurrent protection threshold value Iocp (so-called hiccup control).

The overheat protection circuit 36 detects a temperature to be monitored and controls the gate control signal VG to perform overheat protection. For example, the overheat protection circuit 36 may forcibly turn off and restart the power MISFET 9 in a repeated manner each time the temperature to be monitored is increased to an overheat protection threshold value Ttsd.

The temperature to be monitored may be a first temperature Temp1 which is detected in a power element formation region including the power MISFET 9. The first temperature Temp1 may be, for example, the pn junction temperature Tj1 of the power element formation region.

The temperature to be monitored may be a temperature difference ΔTemp (=Temp1−Temp2) between the first temperature Temp1 and a second temperature Temp2 detected in a region other than the power element formation region. The second temperature Temp2 may be, for example, the pn junction temperature Tj2 of an analogue circuit formation region or a logic circuit formation region, the case temperature Tc of the semiconductor device 1 or the ambient temperature Ta around the semiconductor device 1.

As described above, in the electronic device B of the present configuration example, the fuse box B40 described previously is replaced by the semiconductor device 1. In other words, when the output current IOUT is excessively increased (for example, several tens of amperes to 100 A), the power MISFET 9 is forcedly turned off, and thus the output current IOUT is restricted or interrupted with high speed and high accuracy. Hence, both the semiconductor device 1 and the control unit B10 can be safely protected. Unlike the configuration using mechanical fuses, even if a failure occurs, there is no need to replace the blown fuse B41 (i).

### <Considerations on Wire Protection Function>

The semiconductor device 1 is an electronic circuit which controls high power. Hence, the semiconductor device 1 has a sufficient capability and robustness to protect not only its own internal circuit but also the load (control unit B10) and the surrounding environment. The semiconductor device 1 is the latest form of electronic relay. Inside the semiconductor device 1, an intelligent protection function is implemented. In an automotive environment, it is desirable to utilize the semiconductor device 1 to control various loads 3 (for example, a light source such as a bulb lamp or an LED (light emitting diode) lamp or other types of electronic control devices).

However, the load (control unit B10) to be driven by the semiconductor device 1 is connected to the battery B20 and the earth via the wires W11 to W13. Hence, the semiconductor device 1 which functions as an electronic fuse preferably has not only the function of protecting its own internal circuit, the load (control unit B10) and the surrounding environment but also the function of protecting the wires W11 to W13.

In modern electrical/electronic devices or electrical/electronic systems (such as vehicles, industrial machines and household appliances), stringent demands on power distribution and energy management architectures are increasingly required. As architectures are more complex, while an increasing number of electronic circuits and loads are being controlled and driven, higher robustness, that is, higher safety levels are required.

Even the most advanced wire-melting fuses (mechanical fuses) have difficulty in meeting these requirements. In order to enhance system fault tolerance and to add short circuit or overload protection, an alternative to the wire-melting fuse is needed. Furthermore, only the use of the wire-melting fuse is not appropriate due to other requirements caused by increasingly complex distribution architectures such as a self-resetting function. A vehicle having highly automated driving requirements need to replace or supplement standard melting fuses or fuse boxes.

In today's applications, it is essential to maintain a thermal budget (thermal history) imposed on the insulation material of a harness within an acceptable range to protect the harness, a connector and a PCB (printed circuit board) trace. Hence, a new electronic circuit breaker or an electronic fuse (e-fuse) is needed.

The IPD which can constantly monitor a current flowing through the harness to estimate/emulate the temperature of wires can interrupt the flow of energy through the harness to the load at an arbitrary timing. Such an IPD can also restart supplying the current after an appropriate cooling period has elapsed and thereby can function as a self-resettable fuse. In this way, the harness is protected, and thus system fault tolerance is enhanced.

Furthermore, in an IPD which has an analog or digital interface, harness protection parameters (such as a wire area and the wire allowable temperature upper limit of the insulation material) can be pre-programmed. Hence, the IPD as described above is used as an electronic fuse, and thus a reduction in the costs of the device or the entire system is facilitated.

A plurality of IPDs described above are used in series or in combination with a conventional wire-melting fuse, and thus flexibility at the architectural level is enhanced. In this way, the electronic fuse disclosed in the present disclosure is used, and thus it is possible to enhance the flexibility of an architecture at the system level without any restriction.

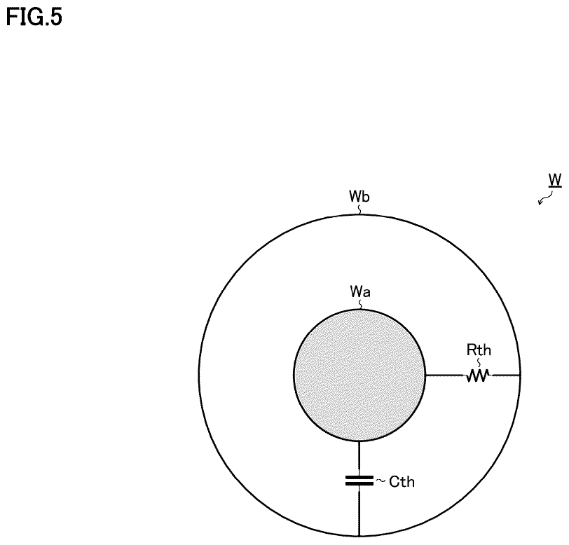

FIG. 5 is a diagram showing a cross section of a wire W. The wire W can be understood to be the wires W11 to W13 described above. In general, the wire W includes a conductor Wa and an insulator Wb covering the conductor Wa. The conductor Wa may be a copper wire subjected to anneal treatment. The insulator Wb may be a polymer of XLPE (cross-linked polyethylene) or the like. The maximum heat generation amount of the insulator Wb is restricted. Hence, the wire W needs to be protected. The heat resistance of the insulator Wb is assumed to be Rth. The heat capacity of the insulator Wb is assumed to be Cth.

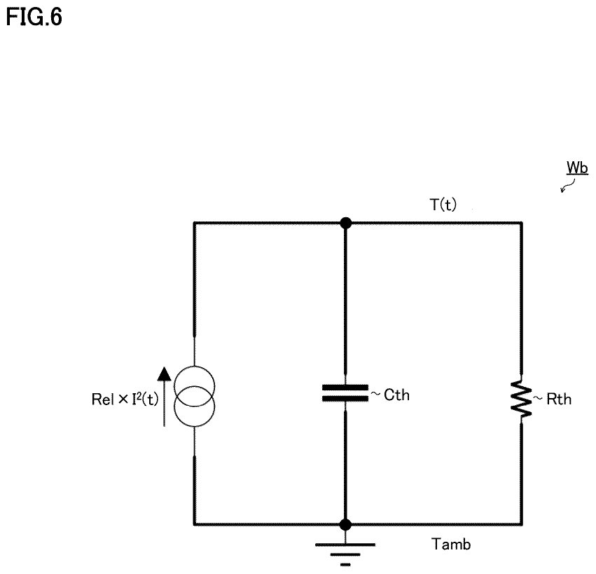

FIG. 6 is a diagram showing an equivalent model of the insulator Wb. As shown in the figure, the insulator Wb can be modeled as a time constant τ (=Rth×Cth) based on the heat resistance Rth and the heat capacity Cth. A heat source is expressed as the product of the electrical resistance Rel of the conductor Wa and the square of the current I (t) flowing through the wire W (=Rel×I² (t)) where the heat resistance Rth, the heat capacity Cth and the electrical resistance Rel are values per unit length of the wire W.

A simple frequency region approach using the equivalent model of the insulator Wb is used, and thus the following equation (1) for the temperature T(s) of the wire W is obtained. In the equation (1), Tamb represents the ambient temperature of the wire W.

$$\begin{matrix}[ Math . 1 ] & \\ T ( s ) = Tamb + {I}^{2} ( s ) \times \frac{Rel \times Rth}{1 + s \times ( R t h \times C t h )} & ( 1 )\end{matrix}$$

The equation (1) described above is transformed back into a time region using an inverse Laplace transform, and thus the following equation (2) is obtained.

$$\begin{matrix}[ Math . 2 ] & \\ T ( t ) = Tamb + {I}^{2} ( t ) \times Rel \times Rth \times ( 1 - {exp}^{- \frac{t}{τ}} ) & ( 2 )\end{matrix}$$

The heat capacity Cth (and hence the time constant τ) is very large. Hence, even if an excessively large current flows in the shape of short pulses, it does not cause a significant problem. However, if an overload state (overcurrent state) continues for a long period of time, the insulator Wb is brought into an overheated state where the temperature of the insulator Wb exceeds the allowable temperature upper limit. Therefore, it is necessary to perform overcurrent protection. Furthermore, the insulator Wb is slow to cool after heating. Consequently, not only the peak value of the current I flowing through the wire W but also the actual RMS (root mean square) value is important.

In view of the cooling of the insulator Wb after heating, the equation (2) described above can be rewritten as the following equation (3). In the equation (3), Tinit represents the temperature of the wire before the application of a current pulse.

$$\begin{matrix}[ Math . 3 ] & \\ T ( t ) = Tamb + ( Tinit - Tamb ) \times {exp}^{- \frac{t}{τ}} + {I}^{2} ( t ) \times Rel \times Rth \times ( 1 - {exp}^{- \frac{t}{τ}} ) & ( 3 )\end{matrix}$$

It is found from the equation (3) described above that the heating is due to the Joule effect caused by the electrical resistance Rel (and hence a loss) of the conductor Wa. It is also found that the cooling is due to the heat impedance of the insulator Wb.

Furthermore, it is found from FIG. 5 and FIG. 6 that in a state of thermal equilibrium, that is, in a state where the heat capacity Cth is neglected, the cooling is due to a heat flow (per unit length) from the conductor Wa to the surroundings. Hence, the flow of power is given by {T(t)−Tamb}/Rth (=dT/Rth). A power input or power loss inside the wire W is given by I² (t)×Rel. These two terms need to be equal. Therefore, the following equation (4) is obtained.

$$\begin{matrix}[ Math . 4 ] & \\ I = \sqrt{\frac{d T}{Rel \times Rth}} & ( 4 )\end{matrix}$$

The equation (4) described above can be defined as the allowable current of the wire W.

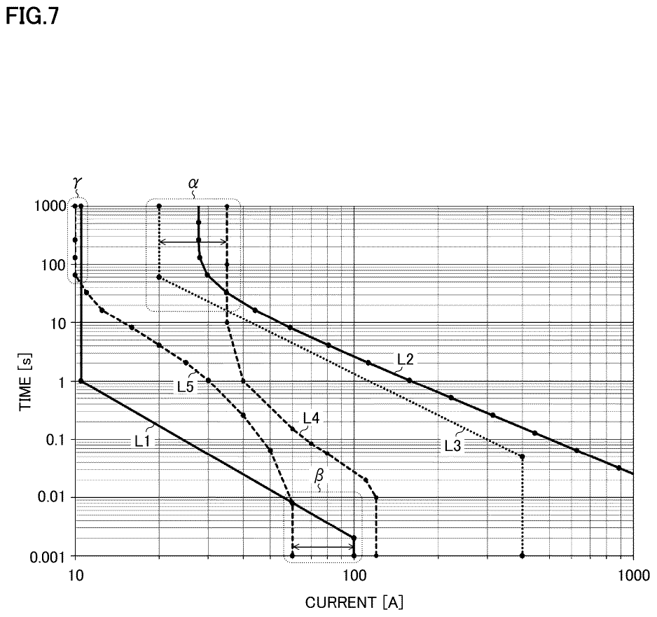

FIG. 7 is a diagram showing a typical current-time characteristic. The horizontal axis (logarithmic axis) represents the magnitude of the current flowing through the harness. The vertical axis (logarithmic axis) represents a current supply time.

A curve L1 indicates a relationship between the magnitude of the current (=load current) which needs to be passed through the harness to drive the load and the current supply time. A curve L2 indicates a relationship between the magnitude of the current (=harness melting current) at which the harness is melted and the current supply time. A curve L3 indicates a relationship between the magnitude of an upper limit current (=harness protection current) set for protecting the harness and the current supply time. Curves L4 and L5 each indicate a relationship between the magnitude of the current (=protection current) at which conventional overcurrent protection operation or overheat protection operation is performed and the current supply time. The curve L4 indicates the protection current of an IPD (=4 mΩ IPD) in which the on-resistance value of the output switch is 4 mΩ. The curve L5 indicates the protection current of an IPD (=8 mΩ IPD) in which the on-resistance value of the output switch is 8 mΩ.

As is found from the comparison between the curves L1 and L4, the protection current of the 4 mΩ IPD can satisfy the load current. However, as is found from the comparison between the curves L3 and L4 (in particular, see a dashed line frame α), the protection current of the 4 mΩ IPD cannot satisfy the harness protection current. On the other hand, as is found from the comparison between the curves L3 and L5, the protection current of the 8 mΩ IPD can satisfy the harness protection current. However, as is found from the comparison between the curves L1 and L5 (in particular, see dashed line frames β and γ), the protection current of the 8 mΩ IPD cannot satisfy the load current.

As described above, in the conventional overcurrent protection or overheat protection, it is difficult to ensure the current necessary to drive the load while protecting the wire (harness) through which the current flows.

If the harness protection current of the curve L3 can be implemented in the IPD by emulating the equation (2) described previously, it is possible to both protect the harness and ensure the current necessary to drive the load. However, in order to emulate the temperature T(t) of the wire W, it is necessary to integrate the square of the current I flowing through the wire W. Hence, it is necessary to measure the RMS value of the current I flowing through the wire W.

In order to calculate an increase in the temperature of the wire W based on the equation (1) described previously, an expensive silicon solution (ADC [analogue-to-digital converter], squaring, filtering, multiplication, integration, digital memory and the like) and/or a microcontroller which can digitize information and perform complex data processing is required.

In view of the considerations described above, the following description proposes an embodiment in which the thermal behavior of the wire W (=the equation (2) described previously) is emulated with a lower-cost circuit configuration, and thus it is possible to both protect the harness and ensure the current necessary to drive the load.

### <Overcurrent Protection Circuit>

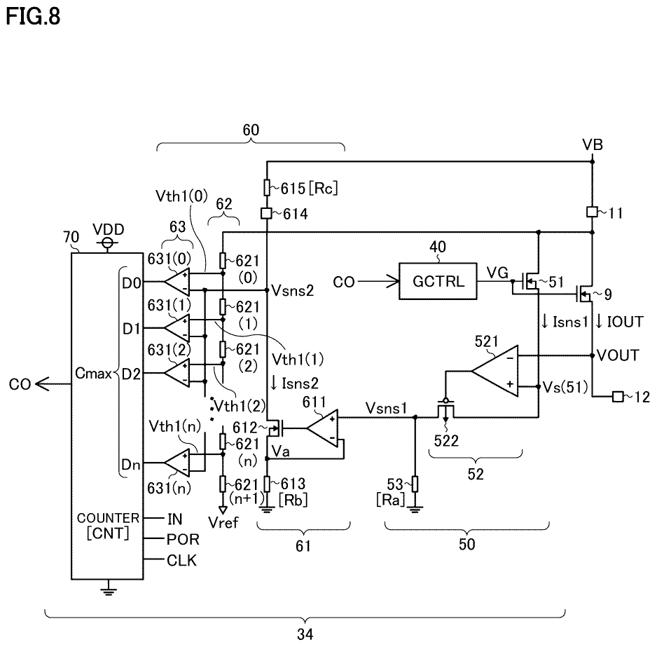

FIG. 8 is a diagram showing an embodiment of the overcurrent protection circuit 34. The overcurrent protection circuit 34 in the present embodiment includes, for example, a sense signal generation circuit 50, a count completion value setting circuit 60 and a counter 70.

The sense signal generation circuit 50 uses, as the current to be monitored, the output current IOUT flowing through the power MISFET 9 (=corresponding to the output switch). The sense signal generation circuit 50 generates a first sense voltage Vsns1 (=corresponding to the sense signal) according to the output current IOUT.

With reference to the figure, the sense signal generation circuit 50 includes a sensor MISFET 51 (for example, an N-channel MISFET), a bias circuit 52 and a resistor 53.

The gate of the sensor MISFET 51 is connected to the gate of the power MISFET 9 (=the application end of the gate control signal VG). The drain of the sensor MISFET 51 is connected to the drain of the power MISFET 9 (=the drain electrode 11). The source of the sensor MISFET 51 is connected to the bias circuit 52 (details of which will be described later). The sensor MISFET 51 connected as described above functions as a sensor switch which is controlled in synchronization with the power MISFET 9 to generate a first sense current Isns1 corresponding to the output current IOUT. The power MISFET 9 may be, for example, an element which has the on-resistance value of 4 mΩ. In other words, the semiconductor device 1 may be a semiconductor device which corresponds to the 4 mΩ IPD.

The bias circuit 52 matches the source voltage Vs (51) of the sensor MISFET 51 with the source voltage of the power MISFET 9 (=the output voltage VOUT). With reference to the figure, the bias circuit 52 includes an amplifier 521 and a transistor 522 (for example, a P-channel MISFET).

The amplifier 521 controls the gate of the transistor 522 such that the source voltage Vs (51) input to the non-inverting input terminal (+) matches the output voltage VOUT input to the inverting input terminal (−).

The source of the transistor 522 is connected to the application end of the source voltage Vs (51). The drain of the transistor 522 is connected to the application end of the first sense voltage Vsns1. The gate of the transistor 522 is connected to the output end of the amplifier 521.

The resistor 53 (resistance value: Ra) functions as a current-voltage conversion element which converts the first sense current Isns1 flowing through the sensor MISFET 51 into the first sense voltage Vsns1 (=Isns1×Ra). The sense signal generation circuit 50 outputs the first sense voltage Vsns1 as the sense signal.

The count completion value setting circuit 60 sets a count completion value Cmax according to results of comparisons between the first sense voltage Vsns1 (in the figure, a second sense voltage Vsns2 corresponding thereto) and a plurality of threshold voltages Vth1 (0) to Vth1 (n). With reference to the figure, the count completion value setting circuit 60 includes a signal adjustment circuit 61, a threshold voltage generation circuit 62 and a comparison circuit 63.

The signal adjustment circuit 61 generates the second sense voltage Vsns2 based on the power supply voltage VB by adjusting the gain and the level of the first sense voltage Vsns1. With reference to the figure, the signal adjustment circuit 61 includes an amplifier 611, a transistor 612 (for example, an N-channel MISFET), a resistor 613, an external electrode 614 and a resistor 615.

The amplifier 611 controls the gate of the transistor 612 such that the first sense voltage Vsns1 input to the non-inverting input terminal (+) matches a node voltage Va input to the inverting input terminal (−).

The source of the transistor 612 is connected to the application end of the node voltage Va. The drain of the transistor 612 is connected to the application end of the second sense voltage Vsns2. The gate of the transistor 612 is connected to the output end of the amplifier 611.

The resistor 613 (resistance value: Rb) is a voltage-current conversion element which converts the node voltage Va into a second sense current Isns2 (=Va/Rb).

The external electrode 614 is connected to the application end of the second sense voltage Vsns2.

The resistor 615 (resistance value: Rc) is externally attached between the drain electrode 11 (=the application end of the power supply voltage VB) and the external electrode 614. The resistor 615 is a current/voltage conversion element which converts the second sense current Isns2 into the second sense voltage Vsns2 (=VB−Isns2×Rc).

For example, as the output current IOUT is increased, the first sense current Isns1 is increased. Hence, the node voltage Va is increased, and thus the second sense current Isns2 is increased. Consequently, the second sense voltage Vsns2 is lowered. By contrast, as the output current IOUT is decreased, the first sense current Isns1 is decreased. Hence, the node voltage Va is lowered, and thus the second sense current Isns2 is decreased. Consequently, the second sense voltage Vsns2 is increased.

The threshold voltage generation circuit 62 generates the threshold voltages Vth1 (0) to Vth1 (n) based on the power supply voltage VB. With reference to the figure, the threshold voltage generation circuit 62 includes resistors 621 (0) to 621 (n+1) which is connected in series between the drain electrode 11 (=the application end of the power supply voltage VB) and the application end of the reference voltage Vref. The reference voltage Vref may be, for example, a floating voltage (=VB−5 V) which is 5V lower than the power supply voltage VB.

A threshold voltage Vth1 (i) (where i=0, 1, . . . and n) is drawn from a connection node between resistors 621(i) and 621(i+1). Here, Vth1 (0)>Vth1 (1)> . . . >Vth1 (n) holds true.

The comparison circuit 63 compares the second sense voltage Vsns2 and the threshold voltages Vth1 (0) to Vth1 (n) to generate a plurality of comparison signals DO to Dn. With reference to the figure, the comparison circuit 63 includes a plurality of comparators 631 (0) to 631 (n).

A comparator 631 (i) (where i=0, 1, . . . and n) compares the second sense voltage Vsns2 input to the inverting input terminal (−) and the threshold voltage Vth1 (i) input to the non-inverting input terminal (+) to generate a comparison signal Di. The comparison signal Di is low when the second sense voltage Vsns2 is higher than the threshold voltage Vth1 (i). The comparison signal Di is high when the second sense voltage Vsns2 is lower than the threshold voltage Vth1 (i).

The count completion value Cmax described previously is set, for example, as a digital signal Dn . . . D1D0 in which the comparison signals D0 to Dn are used as bits for digits. In other words, the count completion value setting circuit 60 can be understood as a simple analog-to-digital conversion circuit.

The counter 70 receives inputs of the count completion value Cmax (=the comparison signals D0 to Dn), the input signal IN, a power-on reset signal POR and a clock signal CLK to generate a counter output signal CO. The counter output signal CO is output to the drive signal output circuit 40 as a forced stop signal (=overcurrent protection signal) for the output current IOUT.

For example, the counter 70 counts up a count value CNT when the comparison signal D0 is high. Then, when the count value CNT reaches the count completion value Cmax, the counter 70 raises the counter output signal CO from low to high to forcibly stop the output current IOUT.

### <Counter>

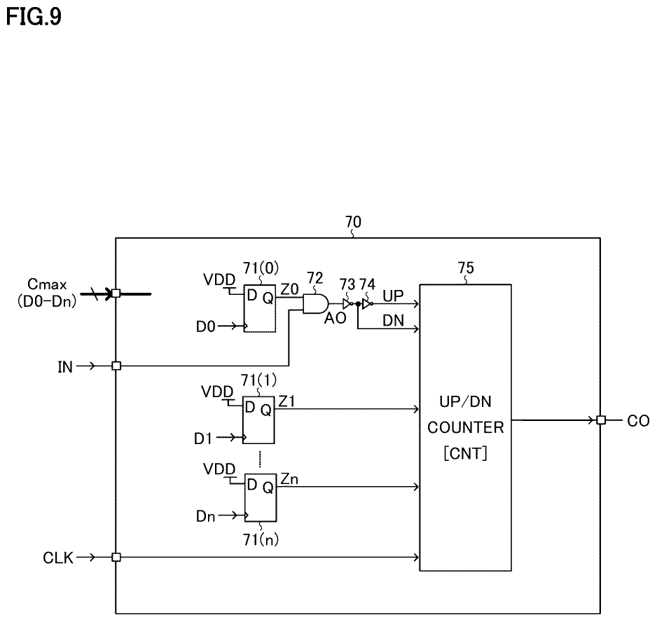

FIG. 9 is a diagram showing an example of the configuration of the counter 70. The counter 70 in the present configuration example includes latch circuits 71 (0) to 71 (n), an AND gate 72, inverters 73 and 74 and an up-down counter 75.

A latch circuit 71 (i) (where i=0, 1, . . . and n) latches the comparison signal Di to generate a latch signal Zi. With reference to the figure, the latch circuit 71 (i) may be a D flip-flop which receives a high-level signal (for example, an internal power supply voltage VDD) input to a data input terminal (D) at a timing at which the comparison signal Di input to a clock input terminal (>) is raised high, and outputs the signal as the latch signal Zi from an output end (Q).

The latch circuit 71 (i) may be reset by the power-on reset signal POR. The latch circuit 71 (0) may be reset at a timing at which the counter output signal CO is raised high.

The AND gate 72 generates a logical product signal AO of a latch signal Z0 and the input signal IN. The logical product signal AO is low when at least one of the latch signal Z0 and the input signal IN is low. The logical product signal AO is high when both the latch signal Z0 and the input signal IN are high.

The inverter 73 inverts the logic level of the logical product signal AO to generate a countdown signal DN. The countdown signal DN is low when the logical product signal AO is high. The countdown signal DN is high when the logical product signal AO is low.

The inverter 74 inverts the logic level of the countdown signal DN to generate a countup signal UP. The countup signal UP is low when the countdown signal DN is high. The countup signal UP is high when the countdown signal DN is low.

The up-down counter 75 counts up or counts down the count value CNT in synchronization with the clock signal CLK. Then, the up-down counter 75 raises the counter output signal CO from low to high when the count value CNT reaches the count completion value Cmax.

The up-down counter 75 counts up the count value CNT when the countup signal UP is high. On the other hand, the up-down counter 75 counts down the count value CNT when the countdown signal DN is high. In other words, the up-down counter 75 switches between the counting up and the counting down of the count value CNT according to the latch signal Z0 corresponding to the least significant bit (=the comparison signal D0) of the digital signal Dn . . . D1D0 among the latch signals Z0 to Zn.

The up-down counter 75 sets the count completion value Cmax according to the remaining latch signals Z1 to Zn.

Although not explicitly shown in the figure, the counter 70 may include an analog or digital interface which accepts an external input of a counter adjustment signal. In the configuration as described above, a user can arbitrarily adjust a relationship between the magnitude of the output current IOUT and the current supply time (for example, the oscillation frequency of the clock signal CLK or the number of series stages in flip-flops of the up-down counter 75). Hence, the user can predefine the maximum temperature increase dT in the wire, a PCB trace or the insulator (see FIG. 5 described previously) of the other electrical interfaces. Consequently, the flexibility of application design is enhanced. In the present configuration, the operation of the electronic fuse is easily adapted to the operation of the mechanical fuse.

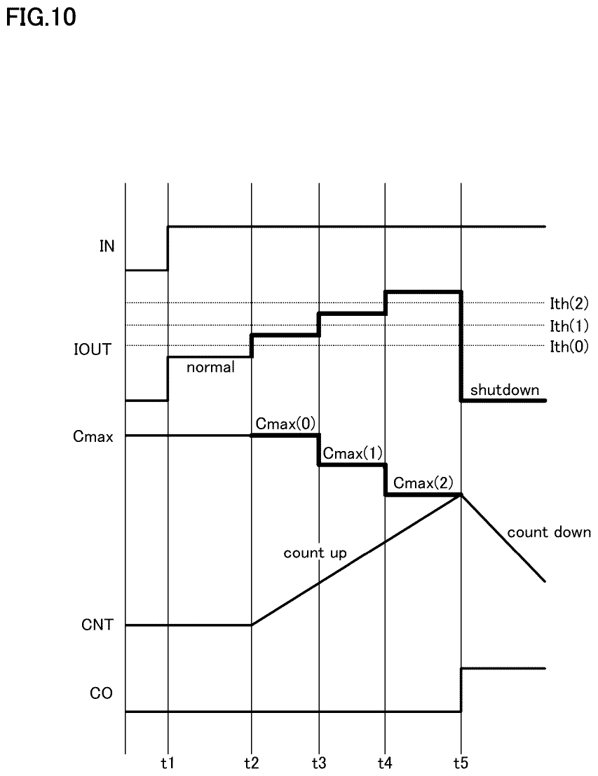

FIG. 10 is a diagram showing an example of an overcurrent protection operation performed by the overcurrent protection circuit 34 in FIG. 8. The figure shows, sequentially from above, the input signal IN, the output current IOUT, the count value CNT, the count completion value Cmax and the counter output signal CO.

When at a time t1, the input signal IN is raised high, the power MISFET 9 is turned on. Consequently, the output current IOUT flows. The output current IOUT during the normal operation is less than a count start threshold value Ith (0). The count start threshold value Ith (0) can be understood as a current value corresponding to the threshold voltage Vth1 (0) described previously. Hence, the comparison signal DO (and hence the latch signal Z0) is switched low, and thus the counting up of the count value CNT is not started. The comparison signals D1 to Dn are also switched low, and thus the count completion value Cmax is set to the highest setting value Cmax (0). The count value CNT does not reach the count completion value Cmax, and thus the counter output signal CO is maintained low.

When at a time t2, the output current IOUT is increased beyond the count start threshold value Ith (0), the comparison signal DO (and hence the latch signal Z0) is switched high. Consequently, the countup signal UP is switched high, and thus the counting up of the count value CNT is started. When the output current IOUT is lower than the threshold value Ith (1), the comparison signals D1 to Dn are kept low. Hence, the count completion value Cmax is maintained at the setting value Cmax (0) described previously. The threshold value Ith (1) can be understood as a current value corresponding to the threshold voltage Vth1 (1) described previously. The count value CNT does not reach the count completion value Cmax, and thus the counter output signal CO is maintained low.

When at a time t3, the output current IOUT is increased beyond the threshold value Ith (1), the comparison signal D1 (and hence the latch signal Z1) is switched high. Consequently, the count completion value Cmax is lowered to the setting value Cmax (1) which is one step lower than the setting value Cmax (0). The threshold value Ith (2) can be understood as a current value corresponding to the threshold voltage Vth1 (2) described previously. The count value CNT does not reach the count completion value Cmax, and thus the counter output signal CO is maintained low.

When at a time t4, the output current IOUT is increased beyond the threshold value Ith (2), the comparison signal D2 (and hence the latch signal Z2) is switched high. Consequently, the count completion value Cmax is lowered to the setting value Cmax (2) which is one step lower than the setting value Cmax (1). The count value CNT does not reach the count completion value Cmax, and thus the counter output signal CO is maintained low.

When at a time t5, the count value CNT reaches the count completion value Cmax, the counter output signal CO is raised high. Consequently, the output current IOUT is forcibly stopped (shut down). When the latch signal Z0 is reset low at a timing at which the counter output signal CO is raised, the countdown signal DN is raised high. Hence, the counting down of the count value CNT is started.

As described above, the count completion value Cmax is preferably lowered as the output current IOUT is increased. In other words, in a state where the output current IOUT is higher than the count start threshold value Ith (0), as the output current IOUT is increased, the output current IOUT is latched off in a shorter time. By contrast, as the output current IOUT is decreased, the output current IOUT is allowed to be supplied in a longer time.

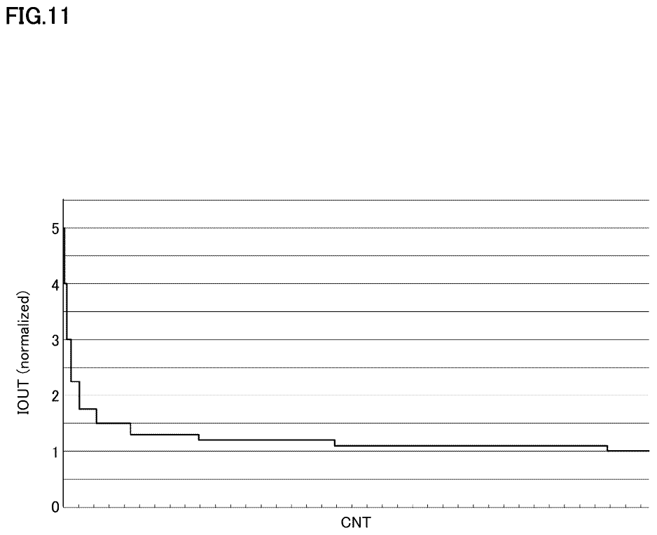

FIG. 11 is a diagram showing a relationship between the count value CNT and the output current IOUT. The horizontal axis represents the count value CNT of the counter 70. The vertical axis represents the output current IOUT normalized to the RMS allowable current of the wire W.

The count value CNT on the horizontal axis may be understood as the count completion value Cmax and hence the current supply time of the output current IOUT. As shown in the figure, it is found that as the output current IOUT is increased, the count value CNT (the count completion value Cmax) is lowered.

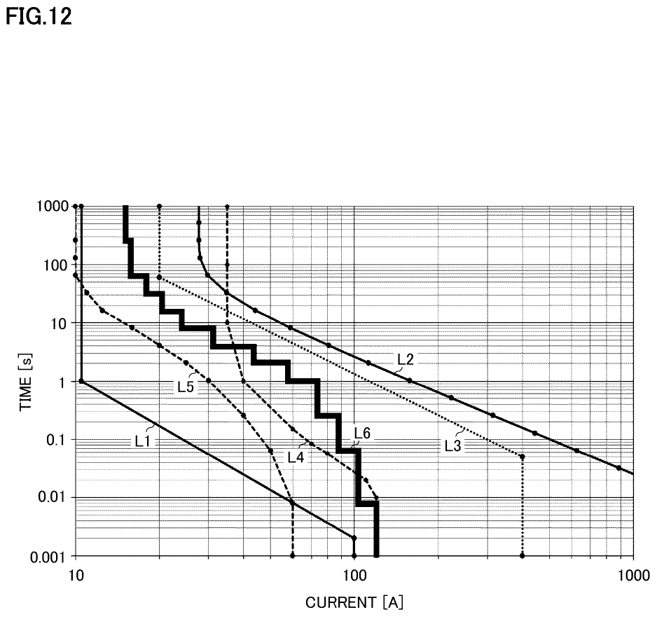

FIG. 12 is a diagram showing a current-time characteristic in the present embodiment. The horizontal axis (logarithmic axis) represents the magnitude of the current flowing through the harness. The vertical axis (logarithmic axis) represents the current supply time.

As in FIG. 7 described previously, curves L1 to L5 indicate the load current, the harness melting current, the protection current of the 4 mΩ IPD and the protection current of the 8 mΩ IPD. A curve L6 indicates a relationship between the magnitude of the current (=protection current) at which the overcurrent protection operation in the present embodiment is performed and the current supply time.

As is found from the comparison between the curves L1 and L6, the protection current in the present embodiment can satisfy the load current. As is found from the comparison between the curves L3 and L6, the protection current in the present embodiment can also satisfy the harness protection current.

As described above, in the overcurrent protection circuit 34 in the present embodiment, without use of an expensive silicon solution and/or a microcontroller, the thermal behavior of the wire W (=the equation (2) described previously) is emulated with a lower-cost circuit configuration, and thus it is possible to both protect the harness and ensure the current necessary to drive the load.

A harness protection function is implemented in the semiconductor device 1, and thus it is also possible to reduce the load of the MCU.

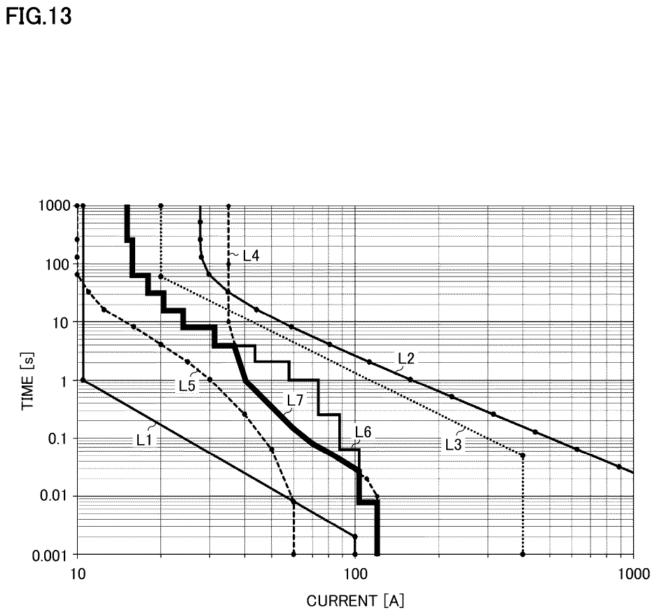

FIG. 13 is a diagram showing a current-time characteristic in a variation of the present embodiment. As shown in a curve L7 in the figure, a plurality of protection functions may be combined such that the lower of the protection current (curve L4) caused by the conventional overcurrent protection and overheat protection and the protection current (curve L6) in the present embodiment is prioritized. For example, the output current IOUT may be forcibly stopped according to the logical sum signal of a first abnormality protection signal generated by the conventional overcurrent protection and overheat protection and a second abnormality protection signal (=the counter output signal CO) generated by the overcurrent protection circuit 34 in the present embodiment.

### Sense Signal Generation Circuit (First Configuration Example)

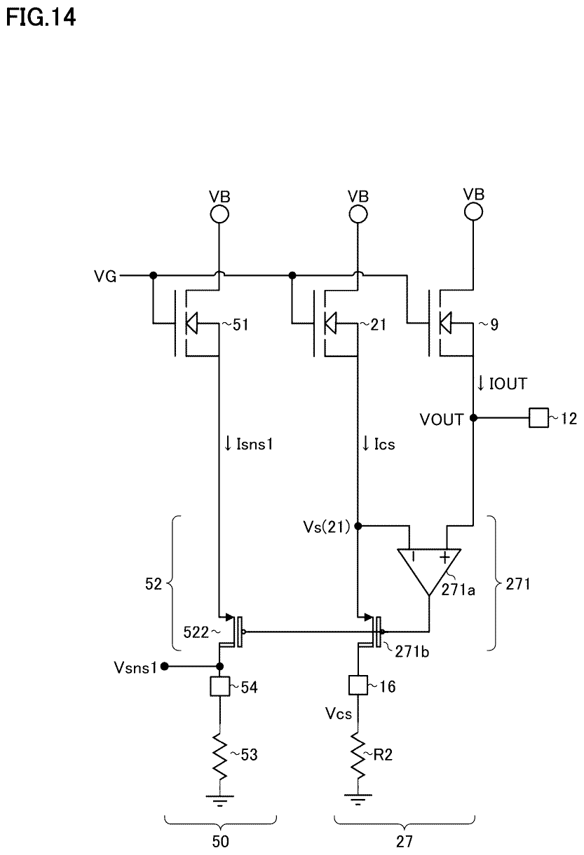

FIG. 14 is a diagram showing the first configuration example of the sense signal generation circuit 50. In the sense signal generation circuit 50 in the present configuration example, based on FIG. 8 described previously, some changes are made.

As a first change, the sense signal generation circuit 50 shares the amplifier (corresponding to the amplifier 521 described previously) in the bias circuit 52 with the current detection circuit 27. With reference to the figure, the current detection circuit 27 includes a bias circuit 271.

The bias circuit 271 matches the source voltage Vs (21) of the sensor MISFET 21 for generating a current signal Ics corresponding to the output current IOUT with the source voltage (=the output voltage VOUT) of the power MISFET 9. With reference to the figure, the bias circuit 271 includes an amplifier 271a and a transistor 271b (for example, a P-channel MISFET).

The amplifier 271a controls the gate of the transistor 271b such that the source voltage Vs (21) input to the non-inverting input terminal (+) matches the output voltage VOUT input to the inverting input terminal (−).

The source of the transistor 271b is connected to the application end of the source voltage Vs (21). The drain of the transistor 271b is connected to the sense electrode 16 (=the application end of a current detection signal Vcs). The gate of the transistor 271b is connected to the output end of the amplifier 271a.

In the sense signal generation circuit 50 in the present configuration example, the gate of the transistor 522 is also connected to the output end of the amplifier 271a. In other words, the bias circuit 52 shares the amplifier 271a of the bias circuit 271. In the present configuration, the amplifier 521 described previously is omitted, and thus the circuit scale of the sense signal generation circuit 50 is decreased.

As a second change, the sense signal generation circuit 50 in the present configuration example includes an external electrode 54 which is connected to the drain of the transistor 522 (=the application end of the first sense voltage Vsns1). The resistor 53 described previously is externally attached between the external electrode 54 and the ground end. In the present configuration, the detection gain of the output current IOUT can be arbitrarily adjusted according to the resistance value of the resistor 53.

### Sense Signal Generation Circuit (Second Configuration Example)

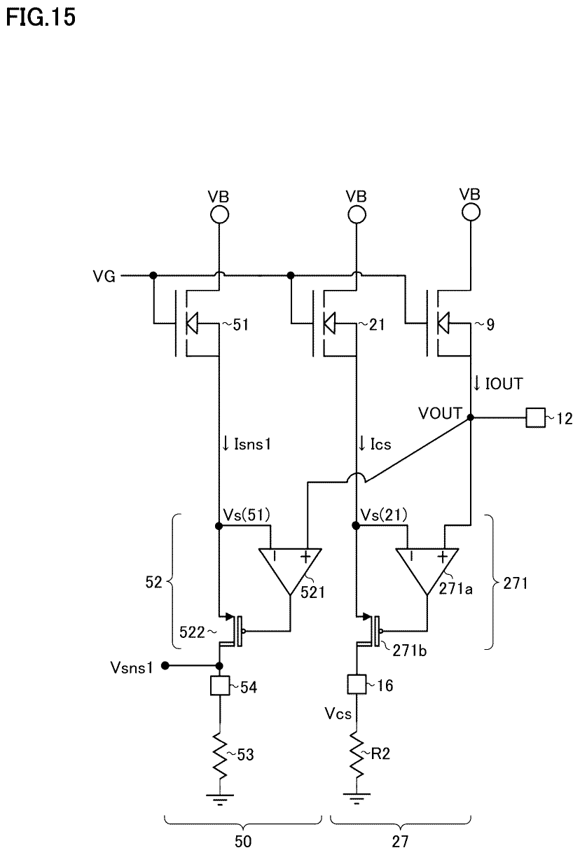

FIG. 15 is a diagram showing the second configuration example of the sense signal generation circuit 50. The sense signal generation circuit 50 in the present configuration example differs from the first configuration example (FIG. 14) described previously in that the bias circuits 52 and 271 include individual amplifiers 521 and 271a, respectively. In the present configuration, the first sense current Isns1 (and hence the first sense voltage Vsns1) can be generated with higher accuracy.

### <Count Completion Value Setting Circuit (Variation)>

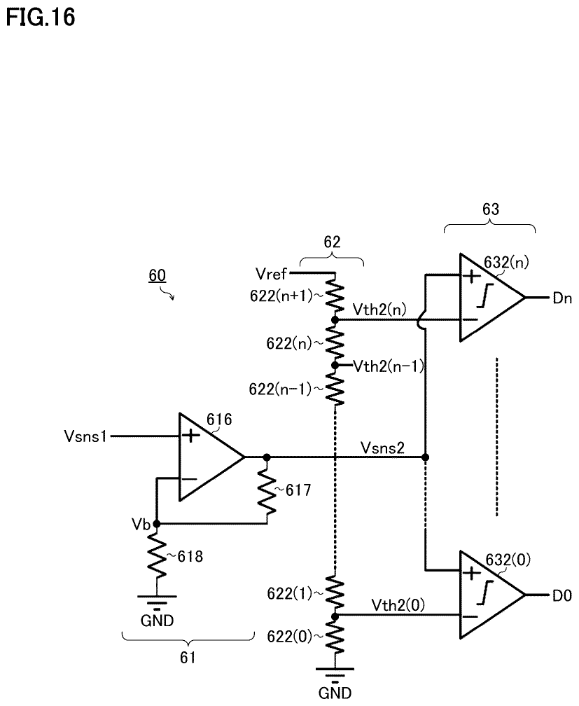

FIG. 16 is a diagram showing a variation of the count completion value setting circuit 60. In the count completion value setting circuit 60 in the present variation, based on FIG. 8 described previously, the level adjustment function is omitted. In other words, in the count completion value setting circuit 60 in the present variation, a reference potential is changed from the power supply voltage VB to a ground voltage GND.

The signal adjustment circuit 61 adjusts the gain of the first sense voltage Vsns1 to generate the second sense voltage Vsns2 based on the ground voltage GND. With reference to the figure, the signal adjustment circuit 61 includes an amplifier 616 and resistors 617 and 618.

The amplifier 616 generates the second sense voltage Vsns2 such that the first sense voltage Vsns1 input to the non-inverting input terminal (+) matches a node voltage Vb input to the inverting input terminal (−).

The resistors 617 and 618 are connected between the application end of the second sense voltage Vsns2 and the ground end (=the application end of the ground voltage GND). The resistors 617 and 618 function as a resistor voltage divider circuit which outputs the node voltage Vb (=the divided voltage of the second sense voltage Vsns2) from a connection node therebetween.

The threshold voltage generation circuit 62 generates threshold voltages Vth2 (0) to Vth2 (n) based on the ground voltage GND. With reference to the figure, the threshold voltage generation circuit 62 includes resistors 622 (0) to 622 (n+1) which are connected in series between the ground end (=the application end of the ground voltage GND) and the application end of the reference voltage Vref.

A threshold voltage Vth2 (i) (where i=0, 1, . . . and n) is drawn from a connection node between resistors 622 (i) and 622 (i+1). Here, Vth2 (0)<Vth2 (1)< . . . <Vth2 (n) holds true.

The comparison circuit 63 compares the second sense voltage Vsns2 and the threshold voltages Vth2 (0) to Vth2 (n) to generate a plurality of comparison signals D0 to Dn. With reference to the figure, the comparison circuit 63 includes a plurality of comparators 632 (0) to 632 (n).

A comparator 632 (i) (where i=0, 1, . . . and n) compares the second sense voltage Vsns2 input to the non-inverting input terminal (+) and the threshold voltage Vth2 (i) input to the inverting input terminal (−) to generate a comparison signal Di. The comparison signal Di is low when the second sense voltage Vsns2 is lower than the threshold voltage Vth2 (i). The comparison signal Di is high when the second sense voltage Vsns2 is higher than the threshold voltage Vth2 (i).

As described above, the count completion value setting circuit 60 does not necessarily need to include the level adjustment function.

### <Application to Vehicle>

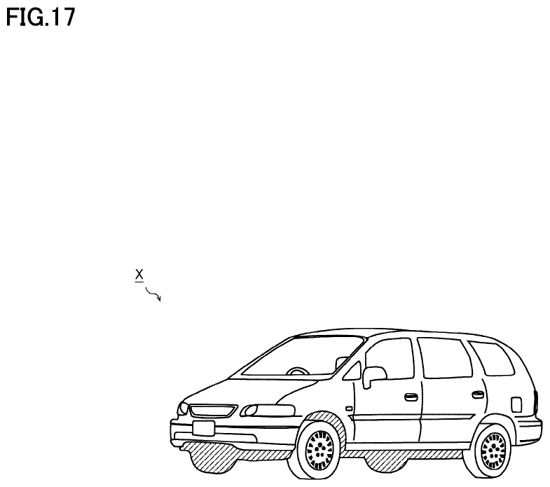

FIG. 17 is a diagram showing an external view of the vehicle X. The vehicle X in the present configuration example incorporates various electronic devices (not shown) which receive supply of power from a battery to operate.

The vehicle X includes not only engine vehicles but also electric vehicles (xEVs such as a BEV [battery electric vehicle], a HEV [hybrid electric vehicle], a PHEV/PHV [plug-in hybrid electric vehicle/plug-in hybrid vehicle] and an FCEV/FCV [fuel cell electric vehicle/fuel cell vehicle]).

The semiconductor device 1 described previously can be installed in any one of the electronic devices incorporated in the vehicle X.

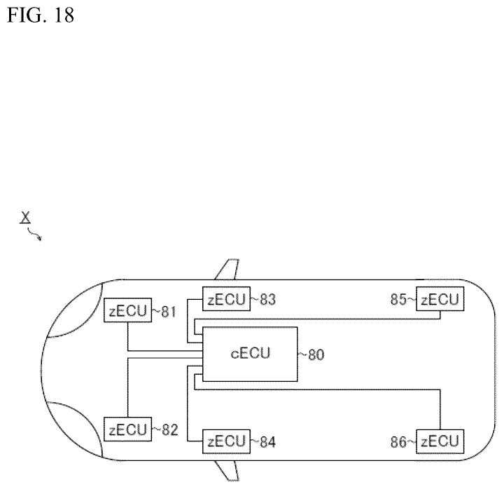

FIG. 18 is a diagram showing a signal system in the vehicle X. With reference to the figure, the vehicle X includes a central ECU 80 and a plurality of zone ECUs 81 to 86. The zone ECUs 81 to 86 are provided in parts of the vehicle X to communicate with the central ECU 80.

For example, the zone ECU 81 is provided on the front right side of the vehicle X to control a headlamp, a turn signal lamp and the like on the right side. The zone ECU 82 is provided on the front left side of the vehicle to control a headlamp, a turn signal lamp and the like on the left side. The zone ECU 83 is provided on the right side of the vehicle X to control an electric side mirror and the like on the right side. The zone ECU 84 is provided on the left side of the vehicle X to control an electric side mirror and the like on the left side. The zone ECU 85 is provided on the rear right side of the vehicle X to control a tail lamp, a turn signal lamp and the like on the right side. The zone ECU 86 is provided on the rear left side of the vehicle X to control a tail lamp, a turn signal lamp and the like on the left side.

A plurality of semiconductor devices 1 described above are preferably provided as electronic fuses such that the zone ECUs 81 to 86 are used as loads. In the configuration as described above, the length and the diameter of the harness can be optimized. The central ECU 80 and the zone ECUs 81 to 86 are operated in conjunction with each other to provide optimal power supply.

### ADDITIONAL REMARKS

The disclosure described above will be additionally remarked below.

For example, an overcurrent protection circuit according to the present disclosure includes: a sense signal generation circuit configured to generate a sense signal according to a current to be monitored; a count completion value setting circuit configured to set a count completion value according to results of comparisons between the sense signal or a signal corresponding thereto and a plurality of threshold values; and a counter configured to count up a count value when the current to be monitored is greater than a count start threshold value, and to forcibly stop the current to be monitored when the count value reaches the count completion value (first configuration).

In the overcurrent protection circuit in the first configuration, the count completion value may be lowered as the current to be monitored is increased (second configuration).

In the overcurrent protection circuit in the first or second configuration, the count completion value setting circuit may include: a signal adjustment circuit configured to generate a second sense signal by adjusting at least one of a gain and a level of the sense signal; and a comparison circuit configured to compare the second sense signal and the plurality of threshold values to generate a plurality of comparison signals, and the count completion value may be set as a digital signal in which the plurality of comparison signals are used as bits for digits (third configuration).

In the overcurrent protection circuit in the third configuration, the counter may include: a plurality of latch circuits configured to latch the plurality of comparison signals to generate a plurality of latch signals, respectively; and an up-down counter configured to count up or count down the count value in synchronization with a clock signal, and the up-down counter may switch between the counting up and the counting down of the count value according to a latch signal corresponding to a least significant bit of the digital signal among the plurality of latch signals, and set the count completion value according to the remaining latch signals (fourth configuration).

For example, a semiconductor device according to the present disclosure includes: an output switch; and the overcurrent protection circuit in any one of the first to fourth configurations, and the overcurrent protection circuit detects an output current flowing through the output switch as the current to be monitored (fifth configuration).

In the semiconductor device in the fifth configuration, the sense signal generation circuit may include: a sensor switch configured to be controlled in synchronization with the output switch to generate a sense current corresponding to the output current; a bias circuit configured to match a node voltage of the sensor switch with a node voltage of the output switch; and a current-voltage conversion circuit configured to convert the sense current into a sense voltage, and the sense signal generation circuit may output the sense voltage as the sense signal (sixth configuration).

The semiconductor device in the sixth configuration may further include: a current detection circuit configured to generate a current detection signal corresponding to the output current, and the sense signal generation circuit may share an amplifier in the bias circuit with the current detection circuit (seventh configuration).

For example, an electronic device according to the present disclosure includes: the semiconductor device in any one of the fifth to seventh configurations; and a load configured to receive supply of the output current from the semiconductor device to operate (eighth configuration).

For example, a vehicle according to the present disclosure includes: the electronic device in the eighth configuration; a battery configured to supply power to the electronic device; and a wire configured to serve as a current path from the battery to the electronic device (ninth configuration).

The vehicle in the ninth configuration may further include: a central ECU (electronic control unit); and a plurality of zone ECUs provided at parts of the vehicle and configured to communicate with the central ECU, and a plurality of semiconductor devices each being the semiconductor device may be provided such that each of the plurality of zone ECUs is used as the load (tenth configuration).

According to the present disclosure, it is possible to ensure a necessary current while protecting a wire (harness) flowing through the current.

### OTHERS

In various technical features disclosed in the present specification, in addition to the embodiments described above, various changes can be added without departing from the spirit of the technical creation. In other words, it should be considered that the embodiments described above are illustrative in all respects, and not restrictive. It is understood that the technical scope of the present disclosure is not limited to the embodiments described above and includes meanings equivalent to the scope of claims and all changes in the scope.

1. An overcurrent protection circuit comprising:
a sense signal generation circuit configured
to generate a sense signal according to a current to be monitored;
a count completion value setting circuit configured
to set a count completion value according to results of comparisons between the sense signal or a signal corresponding thereto and a plurality of threshold values; and
a counter configured
to count up a count value when the current to be monitored is greater than a count start threshold value, and
to forcibly stop the current to be monitored when the count value reaches the count completion value.

2. The overcurrent protection circuit according to claim 1,
wherein the count completion value is lowered as the current to be monitored is increased.

3. The overcurrent protection circuit according to claim 1,
wherein the count completion value setting circuit includes:
a signal adjustment circuit configured to generate a second sense signal by adjusting at least one of a gain and a level of the sense signal; and
a comparison circuit configured to compare the second sense signal and the plurality of threshold values to generate a plurality of comparison signals, and
the count completion value is set as a digital signal in which the plurality of comparison signals are used as bits for digits.

4. The overcurrent protection circuit according to claim 3,
wherein the counter includes:
a plurality of latch circuits configured to latch the plurality of comparison signals to generate a plurality of latch signals, respectively; and
an up-down counter configured to count up or count down the count value in synchronization with a clock signal, and
the up-down counter
switches between the counting up and the counting down of the count value according to a latch signal corresponding to a least significant bit of the digital signal among the plurality of latch signals, and
sets the count completion value according to the remaining latch signals.

5. A semiconductor device comprising:
an output switch; and
the overcurrent protection circuit according to claim 1,
wherein the overcurrent protection circuit detects an output current flowing through the output switch as the current to be monitored.

6. The semiconductor device according to claim 5,
wherein the sense signal generation circuit includes:
a sensor switch configured to be controlled in synchronization with the output switch to generate a sense current corresponding to the output current;
a bias circuit configured to match a node voltage of the sensor switch with a node voltage of the output switch; and
a current-voltage conversion circuit configured to convert the sense current into a sense voltage, and
the sense signal generation circuit outputs the sense voltage as the sense signal.

7. The semiconductor device according to claim 6 further comprising:
a current detection circuit configured to generate a current detection signal corresponding to the output current,
wherein the sense signal generation circuit shares an amplifier in the bias circuit with the current detection circuit.

8. An electronic device comprising:
the semiconductor device according to claim 5; and
a load configured to receive supply of the output current from the semiconductor device to operate.

9. A vehicle comprising:
the electronic device according to claim 8;
a battery configured to supply power to the electronic device; and
a wire configured to serve as a current path from the battery to the electronic device.

10. The vehicle according to claim 9 further comprising:
a central ECU (electronic control unit); and
a plurality of zone ECUs provided at parts of the vehicle and configured to communicate with the central ECU,
wherein a plurality of semiconductor devices each being the semiconductor device are provided such that each of the plurality of zone ECUs is used as the load.
